(19) United States
(12) Patent Application Publication
(10) Pub. No.: US 2018/0208307 A1
(43) Pub. Date: Jul. 26, 2018

(54) CLEANING APPARATUS AND METHOD FOR CLEANING A SURFACE

(71) Applicant: Gebaeudereinigung Lissowski GmbH, Aachen (DE)

(72) Inventor: Uwe BOEHME, Aachen (DE)

(73) Assignee: Gebaeudereinigung Lissowski GmbH, Aachen (DE)

(21) Appl. No.: 15/743,393

(22) PCT Filed: Apr. 7, 2016
(86) PCT No.: PCT/DE2016/000145

§ 371 Date: Jan. 10, 2018

(30) Foreign Application Priority Data
Jul. 14, 2015 (DE) 10 2015 008 859.9
Jan. 15, 2016 (DE) 10 2016 000 295.6

(51) Int. Cl. B64C 39/02; A47L 11/36

(52) U.S. Cl. CPC B64C 39/02; A47L 1/02; A47L 11/36

(57) ABSTRACT

A cleaning apparatus for cleaning façades includes an aerial vehicle with rotors and a cleaning device attached to the aerial vehicle. This cleaning device can clean façades easily, mechanically with brushes or with a cleaning medium such as for example deionized water or dry ice.

The invention relates to a free flying cleaning apparatus for cleaning a surface, with no fixed connection between the cleaning apparatus and the surface. The invention particularly relates to an apparatus for cleaning flat surfaces, such as glass surfaces or faç-ade elements.

Cleaning the inside of glass panes, and particularly the outside thereof is especially difficult when the glass surfaces are large. In high rooms, mobile platforms must be set up so that the surfaces to be cleaned can be reached. On external façades, horizontally and vertically movable work cabins are used to enable the glass and/or façade cleaning personnel to wipe panes which are difficult to reach.

The uniform design of external façades means that other flat surfaces on the inside of buildings must also be cleaned regularly as well as the glass surfaces of the window panes.

Cleaning these surfaces involves a great deal of effort and contributes to the high cost of building maintenance.

Document DE 10 2013 104 447 A1 describes a cleaning apparatus with a self-propelled climbing chassis. Cleaning apparatuses of such kind are only suitable for certain uses due to their complicated mechanical workings and the risk of soiling by the suction pads.

Document WO 2013/076 711 A2 describes a helicopter for cleaning façade surfaces. However, this is not designed to fly freely, and therefore requires a cable connection to a fixed point.

The object underlying the invention is therefore to create a cleaning apparatus of such kind so that it is easier for glass and/or façade cleaning personnel to clean even hard-to-reach windows or façade surfaces.

This object is solved with a cleaning apparatus that includes an aerial vehicle with rotors and a cleaning device fastened to the aerial vehicle for cleaning a surface.

The invention is based on the realization that it is not the glass and/or façade cleaning personnel with their cleaning equipment who have to be brought close to the surface to be cleaned, it is sufficient if only the cleaning equipment is transported to the surface that is to be cleaned. If this cleaning equipment is secured to an aerial vehicle in the form of a cleaning device, the aerial vehicle can be brought close to the surface that is to be cleaned with a remote controller so the surface to be cleaned may be cleaned with the cleaning device. In this context, aerial vehicles with rotors are well suited for positioning the cleaning device. These aerial vehicles may also operate autonomously or semi-autonomously.

Aerial vehicles of such kind with rotors are known as UAVs or multicopters. Semi-autonomous multicopter systems are particularly well suited for cleaning glass and façades internally and externally. The surfaces to be cleaned are in particular vertical surfaces in the indoor and outdoor areas of buildings. However, sloping, horizontal or curved surfaces may also be cleaned using the cleaning apparatus. A simple embodiment of a cleaning apparatus of such kind is a quadcopter or hexacopter with a center distance between the rotors of about 1100 mm. The entire aerial vehicle thus has a horizontal span of 80 cm to 120 cm and a structure height of 60 cm to 80 cm.

The aerial vehicle is of lightweight, compact construction and designed for weight economy. The brush system and the sensor system used are implemented taking into account aerodynamic considerations. In this context, the components that are also carried on board—that is to say in particular the cleaning device—are designed to impact maneuverability as little as possible.

The cleaning device is able to spray deionized water.

The cleaning device may be equipped with a spraying device for water, dry ice, demineralized/deionized water. It is advantageous if the cleaning device includes at least one rotating brush. This makes it possible to strengthen the abrasive effect of the cleaning devices as well as moving the cleaning device relative to the surface that is to be cleaned, and thus achieve improved cleaning performance. A wiper or scraper may help to remove particularly stubborn dirt.

It is suggested that the cleaning apparatus be equipped with a camera so that the attitude of the aerial vehicle and the cleaning result may be inspected. This also makes is possible for a window cleaner located at a distance from the aerial vehicle to check the cleaning on a monitor.

A further development of the cleaning apparatus provides that the aerial vehicle has a safety frame to protect the rotors. This safety frame protects not only the rotors but also the surface that is to be cleaned and the operator of the cleaning apparatus. It is advantageous if the entire frame of the multicopter is equipped with a polystyrene core which functions as a frame.

In order to determine the distance of the aerial vehicle from the surface that is to be cleaned, it is suggested that the aerial vehicle have a sensor system for distance measurement and/or contact detection. This sensor system is preferably arranged on the safety frame of the aerial vehicle. Proximity and tactile sensors are provided for this purpose, to respond actively to the approach to an object or direct contact with an object by the aerial vehicle. The object may also be a glass surface that is to be cleaned. For this purpose, special sensors such as ultrasonic sensors may be used to recognize glass.

A particularly good cleaning effect may be achieved with a brush system that is attached permanently to the aerial vehicle. This brush system preferably consists of a plurality of rotating roller brushes, the axles of which are driven by electric motors.

It is advantageous if the cleaning apparatus includes a device that is displaceable on rollers or balls. A fixed distance between roller brush axles and a cleaning surface may be assured for example by free-running plastic rollers. The result of this is that the contact points between the aerial vehicle and the surface to be cleaned is pre-defined by the fixed spatial arrangement of the rollers. In such case, the arrangement of the rollers may be selected such that the attitude of the aerial vehicle relative to the surface for cleaning is fixed when contact is made. This enables the cleaning apparatus to provide a constant cleaning function even while the aerial vehicle is moving.

A special design of the cleaning apparatus provides that the cleaning device is arranged movably with respect to the aerial vehicle, and the aerial vehicle is equipped with a distance meter which measures the distance between the cleaning device and the aerial vehicle. In one apparatus variant, the cleaning device is also arranged movably with respect to the aerial vehicle and the aerial vehicle is equipped with a pressure measuring device that measures the pressure exerted on the aerial vehicle by the cleaning device.

Besides cameras, the cleaning apparatus may be equipped with the following further sensors: inertial measurement units (IMU), GPS, magnetometer, camera, 1D-LIDAR, 2D-LIDAR, mechanical limit switches and proximity switches, and ultrasonic measurement devices. The data from these sensors may be used for controlling and for locating and navigating the aerial vehicle along the surface that is to be cleaned. Analysis of camera images also enables a qualitative evaluation of the cleaning process.

The object underlying the invention is also solved with a method for cleaning surfaces, particularly façades and glass frontage in the outdoor area, in which a cleaning medium is applied with an aerial vehicle to clean the surface that is to be cleaned.

A semi-autonomous control of the aerial vehicle enabling an automatic or semi-automatic launch and landing procedure is advantageous. This enables activities such as refilling a water tank or replacing a rechargeable battery to be carried out quickly. The control may stabilize the aerial vehicle after initial launch at a predetermined distance from the surface to be cleaned. The operator then only has to specify the area that is to be cleaned base on this attitude. The control calculates a corresponding path and stabilizes the aerial vehicle along the surface to be cleaned. When the water reserve is exhausted or the charge level of the rechargeable batteries approaches a critically low value, an automatic landing procedure is initiated so that the batteries can be changed and/or water can be added. When the respective deficiency has been corrected, the aerial vehicle returns automatically to its previous attitude relative to the surface that is to be cleaned.

It is advantageous if a plurality of aerial vehicles is used. Then, one aerial vehicle may work on the surface to be cleaned with its cleaning device until the battery charge or water reserve is exhausted. Then, the first cleaning apparatus with aerial vehicle and cleaning device flies back so that the rechargeable batteries and/or the water reserve can be replenished, and a second cleaning apparatus flies to the site where the first cleaning apparatus stopped its work. In the case of larger areas for cleaning, the second cleaning apparatus may be launched even while the first is still working, so that as little time as possible elapses between working with the first cleaning apparatus and working with the second cleaning apparatus, and a quasi-continuous cleaning process is achieved.

For very large buildings, a squadron of cleaning apparatuses is suggested. In this way, it is possible to carry out the cleaning simultaneously with a plurality of cleaning apparatuses. At the same time, the number of landing sites available may be fewer than the number of cleaning apparatuses since the time for which the vehicle occupies the landing site should be substantially shorter than the cleaning time.

If a plurality of aerial vehicles is used, it is advantageous if they communicate with each other directly or via a central control. In this way, it is ensured both that surfaces are not cleaned twice and that no surfaces go without cleaning.

A pool of aerial vehicles and a pool of cleaning apparatuses may also be made available. This makes it possible to couple an aerial vehicle and a cleaning apparatus according to needs. For example, one cleaning apparatus may be equipped with a brush and another cleaning apparatus may be equipped with a water spraying device. The aerial vehicle may then be coupled with the cleaning apparatus that suits a given situation. In particular, a plurality of aerial vehicle and a plurality of preferably different cleaning apparatuses enable an effective cleaning process.

Whereas a cleaning person should have all cleaning tools and all cleaning agents ready to hand when cleaning a larger façade, the concept according to the invention offers the option of equipping the cleaning apparatus according to needs, and to reconfigure it quickly. Observation of the surface that is to be cleaned while it is being worked on, and storing the data enables even surfaces with stubborn dirt to be defined as a site, so that precisely these surfaces may be worked again with another cleaning device afterwards. For this purpose, after the first cleaning an aerial vehicle may fly to exactly those sites which are to be processed again—preferably with a different cleaning agent and/or a different cleaning device.

Deionized water may be used as a cleaning medium. It is known, from DE 20 2004 009 740 U1 for example, to use ionized water to clean surfaces so that removal and drying may be omitted. However, the use of ionized water in conjunction with a free flying cleaning apparatus offers the advantage that when cleaning is carried out from top to bottom the lower regions may have already undergone precleaning due to the water running down, and the water film that still adheres can be dried off very quickly by the wind from the aerial vehicle's rotors. This water may be used to supply a bush system for damping and rinsing the surface to be cleaned.

Alternatively or additionally, dry ice may be used as a cleaning medium. With dry ice (CO₂ pellets), which is sprayed onto façades, for example, a supercooling effect is produced. In conjunction with rotating brushes, this causes dirt deposits to flake off and fall to the ground. DE 20 2013 105 041 U1 describes the principle of using dry ice to cleaning particularly heavily soiled surfaces with a spray gun. However, specifically its use together with an aerial vehicle and a brush results in the dry ice being forced by the wind from the rotors against the surface, where it reacts and leaves no residue behind.

When it encounters an obstacle such as a glass pane or a façade for example, dry ice decomposes into gas-phase components, so no moisture is formed or left behind.

In order to protect all glass panes from damage and at the same time to be able to exert a certain pressure from the cleaning apparatus on the surface to be cleaned, it is suggested that the relative attitude of the aerial vehicle be measured with reference to the surface that is to be cleaned.

Additionally or alternatively, it is suggested that the absolute attitude of the aerial vehicle be measured with reference to the surface that is to be cleaned. For this purpose, stationary fixed points, on the ground for example, or on the façade, may serve as a reference system, in order to define the attitude of the surfaces on a building that are to be cleaned. Fixed points on the façade may be for example corners of the building. It is also possible to lay out a carpet with defined points in front of the building. The attitude of the cleaning device relative to these defined points may then be determined during flight. This makes it possible to determine the contact points in relation to the defined points when contact is made with a surface that is to be cleaned. A carpet of such kind also makes the automatic launch and landing of the cleaning apparatus on this carpet in front of the building easier.

It is advantageous if the aerial vehicle is flown against the surface to be cleaned in such manner that a cleaning device attached to the aerial vehicle is pressed against the surface to be cleaned and moved along the surface. For this purpose, the control holds the multicopter at a certain inclination angle of a few degrees in relation to the surface to be cleaned. This is also called the pitch angle. Upon striking the surface that is to be cleaned, a pressure is created between the surface to be cleaned and the cleaning device resting thereon. This pressure is used as the contact pressure for cleaning brushes, for example, to ensure sustained contact between the cleaning brush and the surface to be cleaned. However, it may also serve to counteract the repelling thrust which forces the cleaning apparatus away for the surface that is to be cleaned as it sprays a cleaning fluid against the surface to be cleaned.

The aerial vehicle may also be flown forcefully against the surface to be cleaned. This increases the pressure of a cleaning brush or scraper against the surface that is to be cleaned. However, this energy may also be weakened by the repelling thrust which is generated when the cleaning apparatus sprays fluid against the surface to be cleaned.

A cleaning system includes a cleaning apparatus, a plurality of surfaces to be cleaned, and a topology that surrounds the surfaces to be cleaned. Reference points of the topology are stored in a data memory, and on the one hand the attitude of the cleaning apparatus relative to these reference points and on the other hand the attitude of the cleaning apparatus relative to the surface to be cleaned is determined, in order to guide the cleaning device along the surfaces that are to be cleaned automatically.

This also makes it possible to clean larger façades with a cleaning apparatus operating autonomously. Depending on the size of the flying device and the degree of soiling of the façade, the surfaces to be cleaned are flown against one or more times to wet them with cleaning fluid, brush the surface, detach dirt particles, rinse off dirt, and if necessary even to dry with warm air or spray the surface with a dirt-repellent film.

Accordingly, in the case of a high-rise building a cleaning apparatus may be programmed so that it cleans all the surfaces that are to be cleaned autonomously and progressively, and then starts from the beginning again, or cleans certain surfaces more often and other surfaces less often. In this context, the aerial vehicle moves the cleaning device from a cleaning agent collection station to the surface that is to be cleaned, then relative to the surface that is to be cleaned during cleaning, and back again to collect more cleaning agent. The cleaning agent collection station and a protected housing for the aerial vehicle and the cleaning device may be provided on the roof of the high-rise building.

It is also possible to couple the aerial vehicle with different cleaning devices, for example only spraying the surface to be cleaned in a first work phase, so that the dirt is loosened, and brushing the surface in a second work phase to brush the loosened dirt off. This may then be rinsed away in a third work phase. The effect of this is that the aerial vehicle must only carry the weight that is absolutely necessary for a specific cleaning operation. Thus for example, the aerial vehicle may first be coupled to a fluid tank and an application nozzle, and afterwards to a brush or brush system additionally or instead. The locating devices may also be made available in such manner that different locating devices are coupled to the aerial vehicle depending on its task. This coupling and uncoupling process preferably takes place automatically. Thus, a preferably modular system of a flying cleaning device for cleaning façades is created.

The cleaning apparatus is configured with a view to enabling the cleaning process to proceed autonomously as far as possible. A cleaning operative should only perform a monitoring function and in case of emergency, and to fill and replace the cleaning containers.

For this, a sensor concept is suggested with which the attitude of the cleaning device relative to the surface that is to be cleaned in both absolute and relative terms.

In the case of buildings with one or up to 10 storeys, a mark carpet is set out at a fixed distance in front of the façade by the cleaning operative. These marks are detected with a camera secured on the aerial vehicle, to determine the attitude of the cleaning device relative to the façade. This attitude serves as the basis for the entire cleaning process. However, when it is very close to or in direct contact with the surface that is to be cleaned, the cleaning apparatus needs more data, because the attitude determined with the aid of the mark carpet may contain minor errors. In this case, ultrasonic and/or optical distance and speed measuring devices are used. LIDAR systems emit laser pulses and detected the light that is scattered back. The distance to the scattering location is calculated from the light travel time of the signals. LIDAR systems are designed for object recognition and environment detection, and are used in the cleaning apparatus to determine the precise distance to the cleaning surface.

In the final step, the tactile sensors then serve to detect contact between the cleaning apparatus and the surface. On the basis of this data, a stabilizer holds the cleaning device in a slightly tilted attitude, so that a relatively light force is exerted on the cleaning surface by the cleaning apparatus. In this context, the speed with which the cleaning apparatus flies forwards is converted into a pressure exerted on the surface by the cleaning apparatus when the surface is struck.

With larger buildings, it is no longer possible to detect marks on the ground. In this case, additional sensors are needed. An underlying model of the building may be used for locating, that is to say to determine the attitude of the cleaning device. Such a model may be created independently in advance, or it may be integrated using a known CAD file of the building, for example. In order to generate such a model independently, a cooperative robot ground-air system may be used. In this case, the aerial vehicle may be equipped with a 3D LIDAR system. This 3D LIDAR system is also used to determine the attitude with reference to the model.

Additional sensor systems may be RGB-D depth cameras and windspeed sensors. With RGB-D cameras, the immediate area of the cleaning device may be detected three-dimensionally. This in turn enables the cleaning device to navigate autonomously even if the cleaning surface is not completely flat. A detection of the surface that is to be cleaned with reference to the topology of the environment also enables it to detect flagpoles, sculptures, ledges, windowsills, balconies, etc., so that on the one hand it does not collide with such obstacles and on the other may used this stationary objects for purposes of orientation.

A measurement of the windspeed preferably on the cleaning device is very important, particularly at relatively high altitudes. This provides the cleaning operative with the capability to respond promptly to a change in the windspeed when the cleaning device is at high altitude.

Three exemplary embodiments are represented in the drawing, and will be described in greater detail in the following text. In the drawing

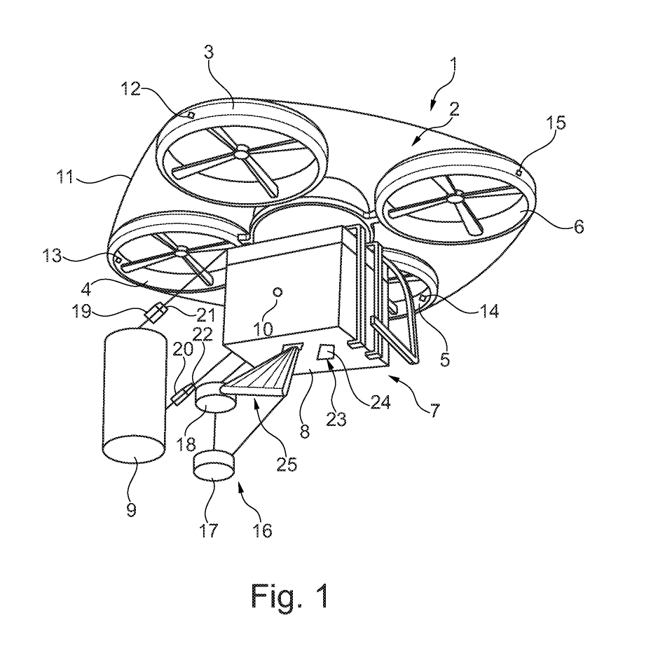

FIG. 1 is a schematic representation of structure of a cleaning apparatus with four rotors,

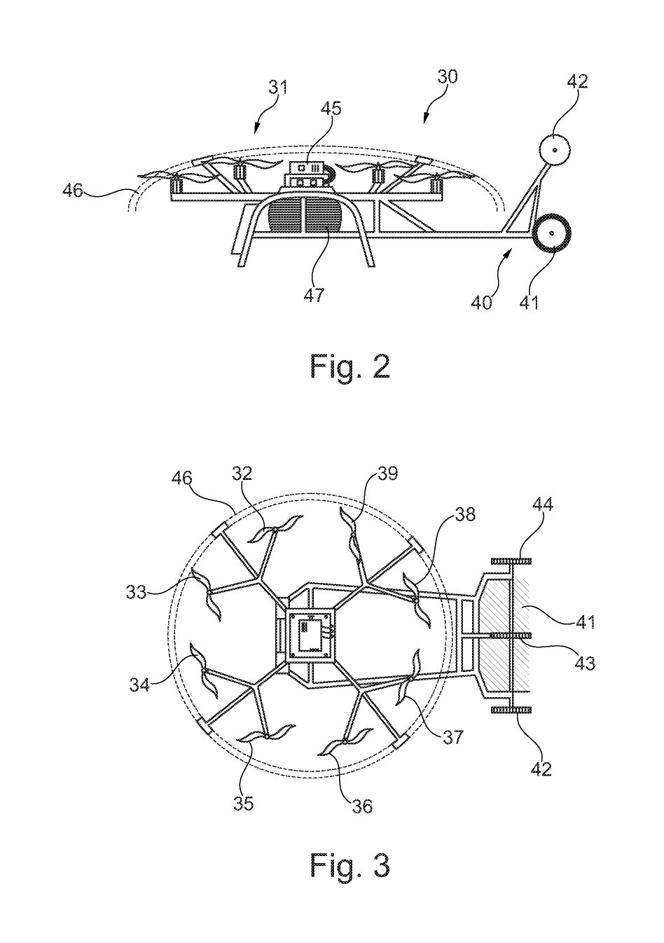

FIG. 2 is a side view of a cleaning apparatus with eight rotors,

FIG. 3 is a plan view of the cleaning apparatus shown in FIG. 2,

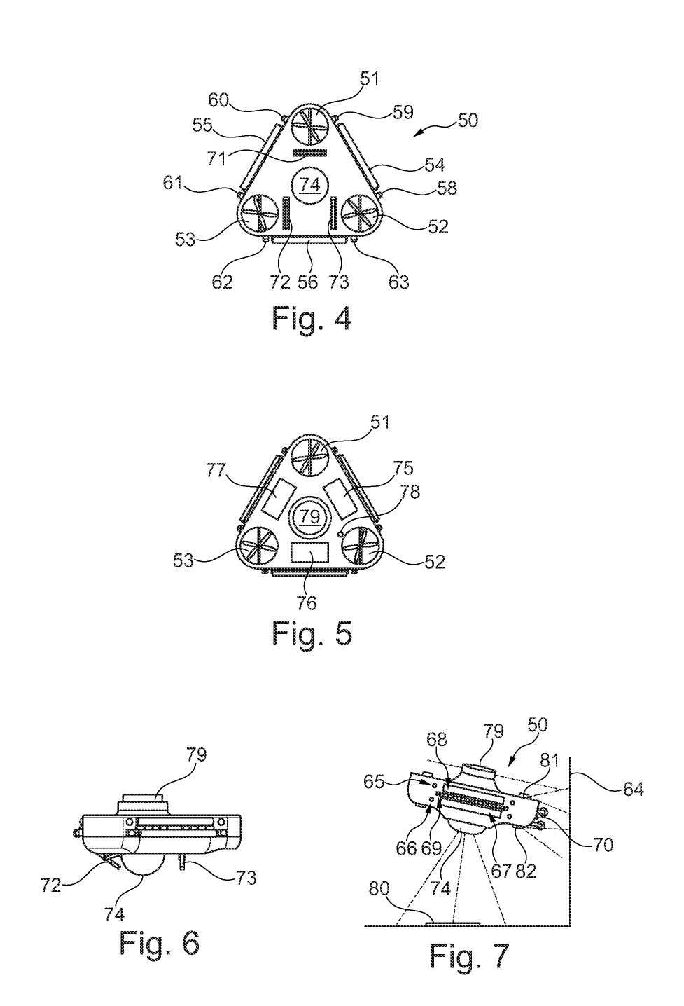

FIG. 4 is a view from below of a cleaning device with three rotors,

FIG. 5 is a view from above of the cleaning device shown in FIG. 4,

FIG. 6 is a side view of the cleaning device shown in FIG. 4,

FIG. 7 is a side view of the cleaning device shown in FIG. 4 with mark carpet,

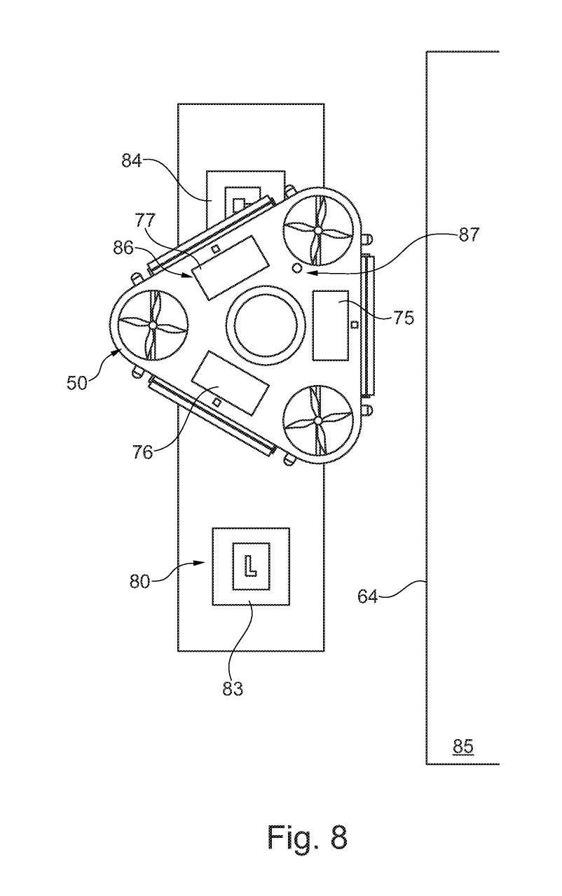

FIG. 8 is a plan view in accordance with FIG. 7,

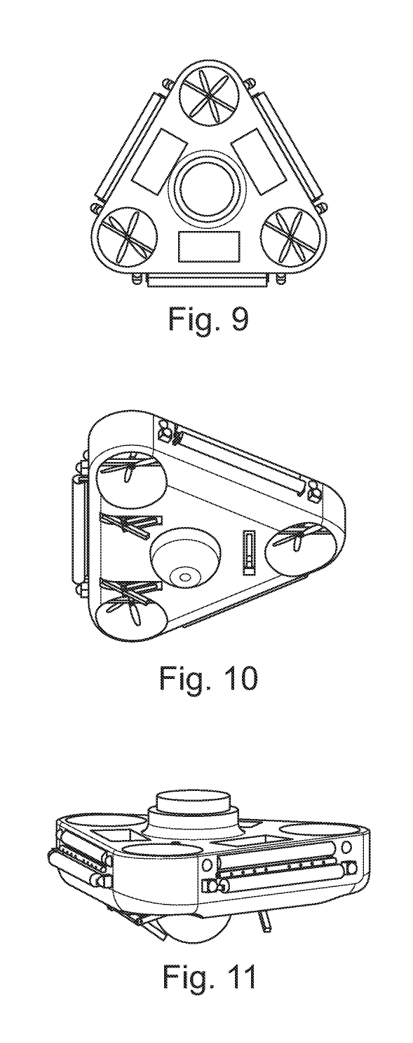

FIG. 9 is a perspective plan view of the cleaning device shown in FIG. 4,

FIG. 10 is a perspective view of the underside of the cleaning device shown in FIG. 4, and

FIG. 11 is a perspective side view of the cleaning device shown in FIG. 4.

Cleaning apparatus 1 includes an aerial vehicle 2 with rotors 3, 4, 5, 6. A cleaning device 7 is attached to said aerial vehicle 2 for cleaning a surface (not shown).

Cleaning device 7 consists of a base body 8, to which cleaning equipment such as a rotating brush 9 is attached. Multiple rotating brushes 9 may also be arranged around base body 8 instead of one rotating brush 9.

A camera 10 is also integrated in base body 8. Multiple cameras or one camera with multiple optical systems may also be arranged on the aerial vehicle instead of one camera 10.

A safety frame 11 for protecting rotors 3, 4, 5 and 6 is provided on aerial vehicle 2 to avoid collisions with people and objects.

Sensors 12 to 15 are provided on aerial vehicle 2 and together form a sensor system for measuring distance and/or detecting contact.

In order to maintain a constant distance from a surface that is to be cleaned, a device 16 that is movable on rollers is provided and is arranged between the base body 8 and the surface that is to be cleaned in such manner that rollers 17, 18 roll over the surface to be cleaned while cleaning device 7 moves relative to the surface that is to be cleaned. Only two rollers 17 and 18 are shown in the figure. It is advantageous additional rollers are arranged on the circumference of aerial vehicle 2.

Brushes 9 of cleaning device 7 may be arranged so as to be movable relative to aerial vehicle 2. Buffer elements 19, 20 with distance meters 21, 22 are used for this purpose. A pressure measuring device (not shown) may also be provided instead of the distance meters or in addition to the distance meters to measure the pressure exerted by the brushes 9 of cleaning device 7 on aerial vehicle 2.

An electronic unit 23 is provided in the base body which also includes measuring devices 24 for controlling the attitude of aerial vehicle 2.

A nozzle 25 makes it possible to apply a cleaning medium such as deionized water or dry ice for example to the surface that is to be cleaned, such as a façade.

The cleaning apparatus 40 shown in FIGS. 2 and 3 includes an aerial vehicle 31 and eight rotors 32 to 39. A cleaning device 40 is attached to aerial vehicle 31, and includes a rotating brush 41 and three spacer wheels 42, 43 and 44. A camera 45 is arranged on the cleaning device and a safety frame 46 is spread over the rotors for the purpose of preventing the rotors from colliding with a person or the surface to be cleaned. Cleaning device 31 includes a cleaning agent reservoir 47 in which deionized water or dry ice may be transported as a cleaning medium.

FIG. 4 shows a cleaning apparatus 50 with three rotors 51, 52 and 53. A cleaning brush 54, 55, 56 is arranged on the outside of base body 57 between each of these rotors. Tactile sensors 58 to 63 are provided to the side of each of the cleaning brushes to determine the distance between base body 57 and a surface to be cleaned 64. The tactile sensors may each be constructed as a sensor pair 65, 66 was illustrated for exemplary purposes in FIG. 7. The cleaning brushes are also preferably designed as brush pairs 67, 68. In this way, it is possible to provide a water supply 69, 70 between two brushes, via which ionized water may be sprayed against the surface to be cleaned 64.

A retractable landing skid with three landing feet 71, 72 and 73 which can be extended at least during the landing procedure is also provided on the underside of cleaning apparatus 50. A sensor module 74 including a RGBD camera and a 1D LIDAR system is provided in the middle of base body 57.

The view from above shows counter-rotating rotors 51, 52 and 53 and a battery changing system 75, 76 and 77 between each of them. A water tank (not shown) is located inside base body 57, and is accessible through opening 78. A further sensor module 79 including a RGBD camera and a 2D LIDAR system is provided on the top of base body 57.

With sensor module 74, the attitude of cleaning apparatus 50 may be determined relative to a marker carpet 80, and with ultrasonic sensors 81, 82 it is possible to specify the relative attitude of cleaning apparatus 50 with reference to the surface that is to be cleaned 64.

When cleaning apparatus 50 flies against the surface that is to be cleaned 64, cleaning apparatus 50 is slightly inclined so that rotors 51 to 53 are able to move it as far as the surface that is to be cleaned 64. As brushes 67, 68 are positioned on the surface that is to be cleaned 64, the inclined position of apparatus 50 determines the contact pressure on the surface to be cleaned 64. As shown in FIG. 7, the cleaning brushes are mounted flexibly, so that even when cleaning apparatus 50 is in an inclined position relative to the surface that is to be cleaned 64, both brushes 67 and 68 positioned one above the other are able to lie flush against the surface that is to be cleaned 64.

FIG. 8 shows a top view of marker carpet 80, so that markings 83, 84 are also visible. The surface that is to be cleaned 64 is part of a building 85, in front of which the marker carpet 80 can be laid out. Distinctive marking points present in the area, for example on the ground or on building 85, may also be used instead of a marker carpet for positioning cleaning apparatus 50. In the present case, the marker carpet also functions as a landing pad, and when cleaning apparatus 50 has landed the battery replacement systems 57, 67 and 77 on the top 86 of cleaning apparatus 50 as well as the opening 87 for the water tank are easily accessible.

1: A cleaning apparatus (1) for cleaning a surface, the cleaning apparatus being free flying no fixed connection between the cleaning apparatus and the surface, wherein the cleaning apparatus includes an aerial vehicle (2) with rotors (3, 4, 5, 6) and a cleaning device (7) attached to the aerial vehicle (2) for cleaning the surface.

2: The cleaning apparatus according to claim 1, wherein the cleaning device (7) includes at least one rotating brush (9).

3: The cleaning apparatus according to claim 1, wherein the cleaning apparatus includes a camera (10).

4: The cleaning apparatus according to claim 1, wherein the aerial vehicle (2) includes a safety frame (11) to protect the rotors (3, 4, 5, 6).

5: The cleaning apparatus according to claim 1, wherein the aerial vehicle (2) has a sensor system (12, 13, 14, 15) for measuring distance and/or detecting contact.

6: The cleaning apparatus according to claim 1, wherein the cleaning apparatus has a mobile device (16) which is movable on rollers (17, 18).

7: The cleaning apparatus according to claim 1, wherein the cleaning device (7) is arranged so as to be movable relative to the aerial vehicle (2), and the aerial vehicle (2) is equipped with a distance meter (21, 22) which measures the distance between the cleaning device (7) and the aerial vehicle.

8: The cleaning apparatus according to claim 1, wherein the cleaning device (7) is arranged so as to be movable relative to the aerial vehicle (2), and the aerial vehicle (2) has a pressure measurement device which measures the pressure exerted on the aerial vehicle (2) by the cleaning device (7).

9: The cleaning apparatus according to claim 1, wherein the cleaning apparatus is equipped with measuring devices (24) that influence the attitude control of the aerial vehicle (2).

10: A method for cleaning surfaces, particularly façades and outdoor glass frontage, comprising applying a cleaning medium for cleaning the surface that is to be cleaned, and cleaning the surface with an aerial vehicle (2).

11: The method according to claim 10, wherein the cleaning medium is deionized water.

12: The method according to claim 10, wherein the cleaning medium is dry ice.

13: The method according to claim 10, wherein the relative attitude of the aerial vehicle (2) is measured with reference to the surface to be cleaned.

14: The method according to claim 10, wherein the absolute attitude of the aerial vehicle is measured with reference to the surface to be cleaned.

15: The method according to claim 10, wherein the aerial vehicle is flown against the surface to be cleaned in such manner that a cleaning device (7) attached to the aerial vehicle (2) is pressed against the surface to be cleaned and moved along the surface.

16: The cleaning system consisting of a cleaning apparatus according to claim 1, a plurality of surfaces to be cleaned and a topology surrounding the surfaces to be cleaned, in which reference points of the topology are stored in a data memory, the attitude of the cleaning apparatus relative to these reference points and the attitude of the cleaning apparatus relative to the surface to be cleaned are determined in order to guide the cleaning device along the surfaces that are to be cleaned automatically.
